(19) United States
(12) Patent Application Publication
(10) Pub. No.: US 2005/0090402 A1
(43) Pub. Date: Apr. 28, 2005

(54) Use of defined copolymers as adjuvants and agents in the agrotechnical domain

(76) Inventors: Reinhold Dieing, Speyer (DE); Lysander Chrisstoffels, Limburgerhof (DE); Rainer Berghaus, Speyer (DE); Oskar Schmidt, Schifferstadt (DE); Harald Kohle, Bobenheim (DE); Michael Gotsche, Mannheim (DE); Reiner Kober, Fubgonheim (DE)

Correspondence Address: KEIL & WEINKAUF, 1350 CONNECTICUT AVENUE, N.W., WASHINGTON, DC, 20036, US

(21) Appl. No.: 10/495,928

(22) PCT Filed: Nov. 21, 2002
(86) PCT No.: PCT/EP02/13090

(30) Foreign Application Priority Data
Nov. 21, 2001 (DE) 101-56-997.1

(51) Int. Cl. A01N 25/10

(52) U.S. Cl. 504/361

(57) ABSTRACT

The present invention relates to the use of specific amphiphilic copolymers as synergistic adjuvant for agrotechnical applications. Suitable agrotechnical compositions are also described. Thus, the addition of such copolymers makes possible an accelerated uptake of active ingredients by the plant. The copolymers or salts thereof to be used comprise monomer units (i) based on at least one olefin and/or at least one vinyl ether, (ii) based on at least one ethylenically unsaturated dicarboxylic acid and/or at least one ethylenically unsaturated dicarboxylic acid derivative, and, optionally (iii) based on at least one further copolymerizable comonomer.

The present invention relates to the use of specific amphiphilic copolymers as synergistic adjuvant for agrotechnical applications, in particular in the field of crop protection. Suitable agrotechnical compositions are also described.

An important factor with a view to industrial production and application of active ingredients is, besides the optimization of the active ingredient's properties, the development of an efficacious composition. The expert formulation of the active ingredient(s) has the task of creating an ideal balance between properties such as bioactivity, toxicology, possible effects on the environment and costs, some of which are contrary. Moreover, the shelf life and the user friendliness of the composition is to a high degree determined by the formulation.

An aspect which is of particular importance for the activity of an agrotechnical composition is the effective uptake of the active ingredient by the plant. If uptake is via the leaf, a complex transport process results, in which the load of active ingredient, for example herbicide, must first penetrate the waxy cuticle of the leaf and must subsequently diffuse, via the cuticula, to the actual site of action in the subjacent tissue.

The addition to formulations of certain auxiliaries in order to improve the activity is generally known and agricultural practice. This has the advantage that the amounts of active ingredient in the formulation can be reduced while maintaining the activity of the latter, thus allowing costs to be kept as low as possible and any official regulations to be followed. In individual cases it is also possible to widen the spectrum of action since plants where the treatment with a particular active ingredient without addition was insufficiently successful can indeed be treated successfully by the addition of certain auxiliaries. Moreover, the performance may be increased in individual cases by a suitable formulation when the environmental conditions are not favorable. The phenomenon that various active ingredients are not compatible with each other in a formulation can therefore also be avoided.

Such auxiliaries are generally referred to as adjuvants. Frequently, they take the form of surface-active or salt-like compounds. Depending on their mode of action, they can roughly be classified into modifers, actuators, fertilizers and pH buffers. Modifiers affect the wetting, sticking and spreading properties of the formulation. Actuators break up the waxy cuticle of the plant and improve the penetration of the active ingredient into the cuticle, both short-term (over minutes) and long-term (over hours). Fertilizers such as ammonium sulfate, ammonium nitrate or urea improve the absorption and solubility of the active ingredient and may reduce the antagonistic behavior of active ingredients. pH buffers are conventionally used for bringing the formulation to an optimal pH.

Regarding the uptake of the active ingredient into the leaf, surface-active substances can act as modifiers and actuators. In general, it is assumed that surface-active substances can increase the effective contact area of liquid on leaves by reducing the surface tension. Moreover, surface-active substances can dissolve or break up the epicuticular waxes, which can facilitate the absorption of the active ingredient. Furthermore, surface-active substances can also improve the solubility of active ingredients in formulations and thus avoid, or at least delay, crystallization. Finally, they can also affect the absorption of active ingredients by retaining moisture.

Surfactant-type adjuvants are exploited in a number of ways for agrotechnical applications. Depending on the molecular weight and the lipophilic groups (cf. also the generally known HLB system), they can be divided into groups of anionic, cationic, nonionic or amphoteric substances.

Substances which are traditionally used as activating adjuvants are petroleum-based oils. More recently, seed extracts, natural oils and their derivatives, for example of soybeans, sunflowers and coconut, have also been employed.

Synthetic surface-active substances which are conventionally used as actuators usually take the form of polyoxyethylene condensates with alcohols, alkylphenols or alkylamines-with HLB values in the range of from 8 to 13. Moreover, silicone-modified polyethylene oxide adjuvants which have particularly pronounced surface-active properties are also employed owing to their outstanding spreadability. In this context, WO 00/42847, for example, teaches the use of specific alcohol alkoxylates in order to increase the activity of agrotechnical biocide formulations.

Amphiphilic copolymers are frequently employed as detergents in washing and cleaning materials. For example, U.S. Pat. No. 5,008,032 (also EP 0 367 049 A1) describes specific surface-active copolymers which are obtained by copolymerizing olefins and dicarboxylic anhydrides. Another application, of such copolymers, which is described in EP 0 785 717 B1 relates to reducing the sedimentation of metazachlor in aqueous compositions. EP 0 412 389 A1 and WO 91/02094 describe the processing of leather and pelts as a possible application of these copolymers. WO 94/15706 describes the use as dispersants for the preparation of aqueous pigment suspensions.

It is an object of the present invention to provide further uses of such copolymeres.

We have found that this object is achieved by using the copolymers as an adjuvant and by providing agrotechnical compositions comprising certain of these copolymers.

The present invention therefore relates to the use of a copolymer (CP) or of a salt of the copolymer (CP) comprising the monomer units
(i) of at least one olefin and/or at least one vinyl ether,
(ii) at least one ethylenically unsaturated dicarboxylic acid and/or at least one ethylenically unsaturated dicarboxylic acid derivative, and, optionally
(iii) at least one further copolymerizable comonomer as an adjuvant in the treatment of plants.

The copolymers CP have adjuvant, in particular synergistic, properties. Thus, the addition of such copolymers makes possible an accelerated uptake of active ingredients by a plant to be treated with the active ingredient. The adjuvant action results in particular in the following aspects in the treatment of plants with one or more active ingredients:
in comparison higher activity of the active ingredient for a given application rate;
in comparison lower application rate with a given effect;
in comparison better uptake of the active ingredient by the plant, in particular via the leaf, and thus advantages for the post-emergence treatment, in particular the spray treatment of plants.

The use according to the invention aims in particular at the cultivation of plants, agriculture and horticulture. It is intended in particular for controlling undesired plant growth.

Accordingly, the present invention also relates to methods, for the treatment of plants, which correspond to the above intended uses, a suitable amount of copolymer according to the invention being applied.

Particular advantages are achieved in particular in the production of Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera, Zea mays.

In addition, copolymers to be used in accordance with the invention may also be used in crops which tolerate the effect of herbicides. Such crops can be obtained for example by breeding and also by recombinant methods.

At least some of the copolymers to be used is known per se. For example, U.S. Pat. No. 5,008,032, EP 0 785 717 B1, EP 0 412 389 A1, WO 91/02094 and WO 94/15706 describe suitable copolymers. The description of these copolymers in these publications is herewith expressly referred to, whereby the copolymers themselves which are disclosed therein and also their preparation are incorporated into the present disclosure.

For the purposes of the present disclosure, the term “monomer unit” refers to a monomer which has been incorporated into the polymer, where the monomer which has been incorporated into the polymer, i.e. the monomer unit, has not only, owing to the polymerization reaction, undergone a structural modification in comparison with the actual monomer introduced into the polymerization reaction, but which can additionally also exhibit further modifications. Thus, in particular the monomer units of the dicarboxylic acids or dicarboxylic acid derivatives can be derived from the monomers introduced into the reaction by means of partial or complete solvolysis, i.e. in particular hydrolysis, alcoholysis or aminolysis, and/or derivatization, i.e. in particular esterification, amidation or imidation, and/or by neutralization.

Substances which are suitable as olefins for the monomer units (i) are, in principle, any unsaturated hydrocarbons which have at least one ethylenically unsaturated polymerizable double bond. Olefins with a terminal double bond are advantageous. Monoethylenically unsaturated olefins are preferred. Monoethylenically unsaturated olefins with a terminal double bond are especially preferred.

Preferred olefins have 4 to 40, in particular 4 to 24 and preferably 8 to 24 carbon atoms. In accordance with a particular embodiment, the olefins have 8 or 18 or 20 to 24 carbon atoms.

Suitable olefins include, for example, but-1-ene, but-2-ene, butadiene, 2-methylprop-1-ene (isobutene), pent-1-ene, isoprene, 2-methylbut-1-ene, 3-methylbut-1-ene, hex-1-ene, cyclohexadiene, 2-methylpent-1-ene, 3-methylpent-1-ene, 4-methylpent-1-ene, 2-ethylbut-1-ene, 4,4-dimethylbut-1-ene, 2,4-dimethylbut-1-ene, 2,3-dimethylpent-1-ene, 3,3-dimethylpent-1-ene, 2,4-dimethylpent-1-ene, 3,4-dimethylpent-1-ene, 4,4-dimethylpent-1-ene, oct-1-ene, 2,4,4-trimethylpent-1-ene, 2,4,4-trimethylpent-2-ene, diisobutene, in particular one which presents itself technically as an isomer mixture of, essentially, 2,4,4-trimethylpent-1-ene and 2,4,4-trimethylpent-2-ene, for example in a ratio of approx. 80% by weight to approx. 20% by weight, 4,4-dimethylhex-1-ene, 2-ethylhex-1l-ene, oligo- and polyisobutenes with a molecular weight of less than 2 000, oligopropenes with a molecular weight of less than 1 000, dec-1-ene, dodec-1-ene, tetradec-1-ene, hexadec-1-ene, heptadec-1-ene, octadec-1-ene, C₁₈-olefin-1, C₂₀-olefin-1, C₂₂-olefin-1, C₂₄-olefin-1, C₂₀— to C₂₄-olefin-1, C₂₄— to C₂₈-olefin-1, C₃₀-olefin-1, C₃₅-olefin-1, C₃₅-olefin-1, styrene, alkyl-substituted styrenes such as alpha-methylstyrene, tert-butylstyrene, vinyltoluene, cyclic olefins such as cyclooctene, and mixtures of these monomers.

Accordingly, the copolymers comprise in particular monomer units (i) of the formula (VIIp) 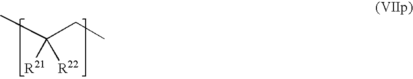
in which
R²¹, R²² independently of one another are hydrogen, branched or linear, saturated or unsaturated C₂₋₃₈-alkyl or unsubstituted or C₁₋₄-alkyl-substituted phenyl.

In formula (VIIp), R²¹ preferably represents hydrogen. Preferred alkyl radicals have 2 and preferably 6 to 22 and, in a particular embodiment, 6 or 16 or 18 to 22 carbon atoms. It is especially preferred that R²¹ is hydrogen and R²² is one of these alkyl radicals.

Preferred among these are isobutene, diisobutene, C₁₈-olefins and C₂₀-C₂₄-olefins.

Vinyl ethers which are particularly suitable for the monomer units (i) are vinyl ethers whose alcohol moiety has 1 to 30 and preferably 1 to 20 carbon atoms. C₁-C₃₀-Alkyl vinyl ethers must be mentioned in particular in this context, it being possible for the alkyl radicals to be linear, branched or cyclic, unsubstituted or substituted. Examples of suitable alkyl vinyl ethers are methyl vinyl ether, ethyl vinyl ether, propyl vinyl ether, isopropyl vinyl ether, butyl vinyl ether, dodecyl vinyl ether.

In accordance with one embodiment, copolymers according to the invention comprise one type of monomer unit (i), for example monomer units of an olefin or of a vinyl ether. In accordance with a further embodiment, copolymers according to the invention comprise two or more types of monomer units (i), for example monomers units of more than one olefin or more than one vinyl ether, or at least one olefin and at least one vinyl ether.

In accordance with a preferred embodiment, the monomer units (i) which are present in the copolymer are essentially composed of monomer units of an olefin.

In accordance with a further preferred embodiment, the monomer units (i) which are present in the copolymer are composed of 25 mol % to 99.9 mol % and in particular 75 mol % to 99.9 mol % monomer units of an olefin and 0.1 mol % to 75 mol % and in particular 0.1 mol % to 25 mol % monomer units of a vinyl ether.

Substances which are suitable as monomer units (ii) are ethylenically unsaturated dicarboxylic acids and their derivatives such as dicarboxylic acid anhydrides, monoesters, diesters, monoamides, diamides and imides.

Ethylenically unsaturated dicarboxylic acids with 4 to 8 and in particular 4 to 6 carbon atoms are preferred in this context.

Substances which must be mentioned in particular are maleic acid, itaconic acid, mesaconic acid, citracoic acid and methylenemalonic acid. Especially preferred among these carboxylic acids are itaconic acid and, for practical reasons, maleic acid.

The same applies analogously to the dicarboxylic acid derivatives.

Accordingly, preferred dicarboxylic anhydrides are itaconic anhydride and in particular maleic anhydride.

The suitable dicarboxylic esters include not only monoesters, but also diesters, whose alcohol moiety can be identical or different. Accordingly, maleic acid monoesters and diesters and itaconic monoesters and diesters are preferred.

The dicarboxylic esters can have linear or branched, saturated or unsaturated, primary, secondary or tertiary alcohol residues as the alcohol moiety. Alcohol residues which must be mentioned in particular in this context are those of the formula (I)
(R¹)ₙ—X—(CHR²CH₂O)_{w}—(CHR³CH₂O)ₓ—(CHR⁴(CH₂)_{y}O)_{z}— (I),
in which
R¹ is hydrogen, or branched or linear, saturated or unsaturated C₁₋₄₀-alkyl;
R², R^{3,} R⁴ independently of one another are hydrogen or C₁₋₄-alkyl;
w, x, z independently of one another correspond to a value of from 0 to 100;
y corresponds to a value of from 1 to 20, preferably of 1;
X is N or O,
where n=1 if X═O, or n=2 and the total of w, x and z amounts to at least 1 if X═N.

Particular embodiments of alcohols of the formula (I) result in the event that w, x and z are zero (non-alkoxylated alcohol residues); in the event that z corresponds to a value of from 1 to 100 and w and x are zero (alkoxylates such as ethoxylates (R⁴═H; y=1) or propoxylates (R⁴═CH₃; y=1); in the event that w is zero and x and z independently of one another correspond to a value of from 1 to 100 (EO—PO block copolymers with, for example, an EO—PO block arrangement(y=1; R³═CH₃; R⁴═H) or a PO-EO block arrangement(y=1; R³═H; R₄═CH₃); in the event that w, x and z independently of one another correspond to a value of from 1 to 100 (EO—PO-EO block copolymers with, for example, an EO—PO-EO block arrangement (y=1; R²═H; R³═CH₃; R⁴═H) or a PO-EO—PO block arrangement(y=1; R²═CH₃; R³═H; R⁴═CH₃)).

Alcohol residues which have proved suitable in accordance with the invention are, in particular, optionally alkoxylated residues of the formula (I) in which R¹ is an alkyl radical having preferably 1 to 30 carbon atoms, the longer-chain radicals and in particular those having 12 to 24 carbon atoms being preferred.

Very especially suitable alcohol alkoxylates and especially alcohol ethoxylate residues are those of the formula (Ia)
R¹—O—(C₂H₄O)_{z}— (Ia)
in which
R¹ has the above meaning and is, preferably, branched or linear, saturated or unsaturated C₁₂₋₂₄-alkyl; and
z corresponds to a value of from 1 to 100 and is preferably between 5 and 100.

The suitable dicarboxylic amides include not only monoamides, but also diamides, with identical or different amine moieties. Accordingly, maleic acid monoamides and diamides and itaconic acid monoamides and diamides are preferred.

The amine moiety of the amides may take the form of ammonia and/or linear or branched, saturated or unsaturated, primary or secondary amines having 1 to 100 and, preferably, 1 to 40 carbon atoms, in particular C₁-C₄₀-alkylamines and di(C₁-C₄₀-alkyl)amines. The alkylamines and dialkylamines can be unsubstituted or substituted. Thus, the alkyl radicals of the amines may have, for example, acid groups or alcohol groups as substituents. Examples are ethylamine, isopropylamine, diisopropylamine, n-butylamine, hexylamine, distearylamine, dioleylamine, ethanolamine, di-n-propanolamine, morpholine or amino acids.

Preferred dicarboxylic acid imides are maleimides and itaconimides. What has been said for the dicarboxamides applies analogously to the amine moiety of suitable dicarboximides.

As a rule, copolymers according to the invention comprise more than one type of monomer unit (ii), for example monomer units of one dicarboxylic acid and at least one dicarboxylic acid derivative. In accordance with a particular embodiment, the monomer units (ii) which are present in the copolymer are derived from a dicarboxylic acid, in particular one of the dicarboxylic acids described above as being preferred. Accordingly, copolymers which have proved to be especially suitable are those whose monomer units (ii) are composed essentially of monomer units of maleic acid and derivatives.

In accordance with a further preferred embodiment, the monomer units (ii) which are present in the copolymer are composed of 0.1 mol % to 99.9 mol % and in particular 25 mol % to 99.9 mol % monomer units of a dicarboxylic acid, advantageously of maleic acid, and 0.1 mol % to 99.9 mol % and in particular 0.1 mol % to 75 mol % monomer units of a dicarboxylic acid derivative, advantageously of a maleic acid monoester, preferably containing one of the abovementioned alcohols of the formula (I) or (Ia).

Accordingly, the copolymers comprise, in particular, monomer units (ii) of the formula (VIIq1) and/or of the formula (VIIq2) 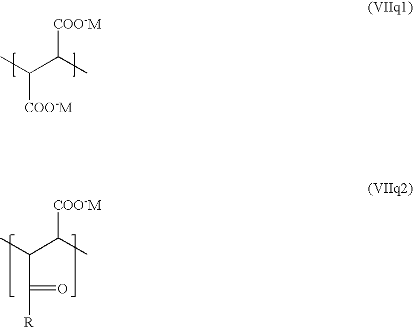
in which
M radicals are in each case independently of one another a hydrogen atom or the equivalent of a cation selected from among alkali metal, alkaline earth metal and transition metal cations, in particular Na⁺, K⁺, Mg⁺⁺, Ca⁺⁺ and Zn⁺⁺, NH₄⁺ and quaternary ammonium cations, in particular alkylammonium, dialkylammonium, trialkylammonium and tetraalkylammonium; and
R is one of the above-described alcohol or amine residues.

In formula (VIIq2), R is preferably an alcohol residue of the formula (I), in particular of the formula (Ia). M is preferably hydrogen or an alkali metal cation.

Suitable as monomer units (iii) are, in principle, any copolymerizable, ethylenically unsaturated comonomers with at least one double bond, in particular monoethylenically unsaturated comonomers.

Examples which must be mentioned in particular are acrylic acid or methacrylic acid and their salts, esters and amides. The salts can be derived from any nontoxic metal, ammonium or substituted ammonium counterions, for example the cations mentioned above under M.

The esters can be derived from linear C₁-C₄₀—, branched C₃-C₄₀— or carbocyclic C₃-C₄₀-alcohols, from polyfunctional alcohols having 2 to approximately 8 hydroxyl groups such as ethylene glycol, hexylene glycol, glycerol and 1,2,6-hexanetriol, from amino alcohols or from alcohol ethers such as methoxyethanol and ethoxyethanol, (alkyl) polyethylene glycols, (alkyl) polypropylene glycols or ethoxylated fatty alcohols, for example C₁₂-C₂₄-fatty alcohols which have been reacted with 1 to 200 ethylene oxide units.

The amides can be unsubstituted, N-alkyl-substituted or N-alkylamino-monosubstituted or N,N-dialkyl-substituted or N,N-dialkylamino-disubstituted, the alkyl or alkylamino groups being derived from linear C₁-C₄₀—, branched C₃-C₄₀— or carbocyclic C₃-C₄₀— units. The alkylamino groups can furthermore be quaternized.

Other comonomeres which can be used as monomer units (iii) are substituted acrylic acids and salts, esters and amides thereof, the substituents being borne by the carbon atoms in position 2 or 3 of the acrylic acid and independently of one another being selected from among C₁-C₄-alkyl, —CN and COOH. Substances which must be mentioned as particularly preferred in this context are methacrylic acid, ethacrylic acid and 3-cyanoacrylic acid. As regards the salts, esters and amides of these substituted acrylic acids, what has been said for the acrylic acids applies analogously.

Especially preferred as component (iii) are comonomers of the formula (II):
Y—C(O)CR⁵═CHR⁶ (II)
in which
Y is selected from among —OH, —OM, —OR⁷, NH₂, —NHR⁷, N(R⁷)₂, it being possible for the radicals R⁷ to be identical or different and being selected from among hydrogen, linear or branched C₁-C₄₀-alkyl, N,N-dimethylaminoethyl, 2-hydroxyethyl, 2-methoxyethyl, 2-ethoxyethyl, hydroxypropyl, methoxypropyl and ethoxypropyl;
M is the equivalent of a cation selected from among alkali metal, alkaline earth metal and transition metal cations, in particular Na⁺, K⁺, Mg⁺⁺, Ca⁺⁺ and Zn⁺⁺, NH₄⁺, and quaternary ammonium cations, in particular alkylammonium, dialkylammonium, trialkylammonium and tetraalkylammonium; and
R⁵, R⁶ independently of one another are selected from among hydrogen, linear or branched C₁-C₈-alkyl, methoxy, ethoxy, 2-hydroxyethoxy, 2-methoxyethoxy and 2-ethoxyethyl.

Others which are suitable are N,N-dialkylaminoalkylacrylates and-methacrylates and N,N-dialkylaminoalkylacrylamides and-methacrylamides of the formula (III)
R¹¹R¹²N—R¹⁰-Z(R⁹)_{g}—C(O)CR⁸═CH₂ (III)
in which
R⁸ is hydrogen or C₁-C₈-alkyl;
R⁹ is hydrogen or methyl;
R¹⁰ is C₁-C₂₄-alkylene which can be substituted by alkyl;
R¹¹ , R¹² independently of one another are C₁₋₄₀-alkyl;
Z is nitrogen if g=1, or oxygen if g=0.

Preferred comonomers of the formula (III) are N,N-dimethylaminomethyl (meth)acrylate, N,N-diethylaminomethyl (meth)acrylate, N,N-dimethylaminoethyl(meth)acrylate, N,N-diethylaminoethyl(meth)acrylate, N-[3-(dimethylamino)propyl]methacrylamide and N-[3-(dimethylamino)propyl]acrylamide. It should be mentioned in this context that the term “(meth)acrylate” represents both “acrylate” and “methacrylate”.

Others which are furthermore suitable are allyl esters of linear C₁-C₄₀—, branched C₃-C₄₀— or carbocyclic C₃-C₄₀-carboxylic acids, vinyl halides or allyl halides, preferably vinyl chloride and allyl chloride, vinylformamide, vinylmethylacetamide, vinylamine; vinyl lactams, preferably vinylpyrrolidone and vinyl caprolactam; vinyl- or allyl-substituted heterocyclic compounds, preferably vinylpyridine, vinyloxazoline and allylpyridine.

Others which are suitable are N-vinylimidazoles of the formula (IV) 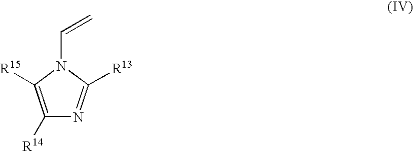
in which
R¹³—R¹⁵ independently -of-one another are hydrogen, C₁-C₄-alkyl or phenyl.

Likewise suitable are diallylamines of the formula (V) 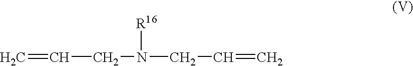
in which
R¹⁶ is C₁-C₂₄-alkyl.

In principle, ethylene, propylene and vinylidene chloride are also suitable as comonomers for the monomer units (iii).

Comonomers for the monomer units (III) which must be mentioned in particular are acrylic acid, methacrylic acid, ethylacrylic acid, methyl acrylate, ethyl acrylate, propyl acrylate, n-butyl acrylate, isobutyl acrylate, t-butyl acrylate, 2-ethylhexyl acrylate, decyl acrylate, methyl methacrylate, ethyl methacrylate, propyl methacrylate, n-butyl methacrylate, isobutyl methacrylate, t-butyl methacrylate, 2-ethylhexyl methacrylate, decyl methacrylate, methyl ethacrylate, ethyl ethacrylate, n-butyl ethacrylate, isobutyl ethacrylate, t-butyl ethacrylate, 2-ethylhexyl ethacrylate, decyl ethacrylate, stearyl (meth)acrylate, 2,3-dihydroxypropyl acrylate, 2,3-dihydroxypropyl methacrylate, 2-hydroxyethyl acrylate, hydroxypropyl acrylates, 2-hydroxyethyl methacrylate, 2-hydroxyethyl ethacrylate, 2-methoxyethyl acrylate, 2-methoxyethyl methacrylate, 2-methoxyethyl ethacrylate, 2-ethoxyethyl methacrylate, 2-ethoxyethyl ethacrylate, hydroxypropyl methacrylate, glyceryl monoacrylate, glyceryl monomethacrylate, polyalkylene glycol (meth)acrylates, unsaturated sulfonic acids such as, for example, acrylamidoptopanesulfonic acid;
acrylamide, methacrylamide, ethacrylamide, N-methylacrylamide, N,N-dimethylacrylamide, N-ethylacrylamide, N-isopropylacrylamide, N-butylacrylamide, N-t-butylacrylamide, N-octylacrylamide, N-t-octylacrylamide, N-octadecylacrylamide, N-phenylacrylamide, N-methylmethacrylamide, N-ethylmethacrylamide, N-dodecyl-methacrylamide, 1-vinylimidazole, 1-vinyl-2-methylvinylimidazole, N,N-dimethylaminomethyl (meth)acrylate, N,N-diethylaminomethyl (meth)acrylate, N,N-dimethylaminoethyl (meth)acrylate, N,N-diethylaminoethyl (meth)acrylate, N,N-dimethylaminobutyl (meth)acrylate, N,N-diethylaminobutyl (meth)acrylate, N,N-dimethylaminohexyl (meth)acrylate, N,N-dimethylaminooctyl-(meth)acrylate, N,N-dimethylaminododecyl (meth)acrylate, N-[3-(dimethylamino)propyl]methacrylamide, N-[3-(dimethylamino)-propyl]acrylamide, N-[3-(dimethylamino)butyl]methacrylamide, N-(8-(dimethylamino)octyl]methacrylamide, N-[12-(dimethylamino)-dodecyl]methacrylamide, N-[3-(diethylamino)propyl]methacrylamide, N-[3-(diethylamino)propyl]acrylamide;

Fumaric acid, crotonic acid, itaconic acid, diallyldimethyl-ammonium chloride, vinylformamide, vinylmethylacetamide, vinylamine; methyl vinyl ketone, vinylpyridine, vinylimidazole, vinylfuran, styrene, styrene sulfonate, allyl alcohol, and mixtures of these.

Especially preferred among these are acrylic acid, methacrylic acid, maleic acid, fumaric acid, crotonic acid, methyl acrylate, methyl methacrylate, ethyl acrylate, ethyl methacrylate, n-butyl acrylate, n-butyl methacrylate, t-butyl acrylate, t-butyl methacrylate, isobutyl acrylate, isobutyl methacrylate, 2-ethylhexyl acrylate, stearyl acrylate, stearyl methacrylate, N-t-butylacrylamide, N-octylacrylamide, 2-hydroxyethyl acrylate, hydroxypropyl acrylates, 2-hydroxyethyl methacrylate, hydroxypropyl methacrylates, alkylene glycol (meth)acrylates, styrene, unsaturated sulfonic acids such as, for example, acrylamidopropanesulfonic acid, vinylpyrrolidone, vinyl caprolactam, vinylformamide, vinylmethylacetamide, vinylamine, 1-vinylimidazole, 1-vinyl-2-methylimidazole, N,N-dimethylamino-methyl methacrylate and N-[3-(dimethylamino)propyl]meth-acrylamide; 3-methyl-1-vinylimidazolium chloride, 3-methyl-1-vinylimidazolium methylsulfate, quaternized N,N-dimethylaminoethyl methacrylate, N-[3-(dimethylamino)propyl]methacrylamide.

Comonomers or corresponding monomer units with a basic nitrogen atom can be quaternized in the following manner:

Suitable for quaternizing the amines are, for example, alkyl halides having 1 to 24 carbon atoms in the alkyl group, for example methyl chloride, methyl bromide, methyl iodide, ethyl chloride, ethyl bromide, propyl chloride, hexyl chloride, dodecyl chloride, lauryl chloride and benzyl halides, in particular benzyl chloride and benzyl bromide. Further suitable quaternizing agents are dialkyl sulfates, in particular dimethyl sulfate or diethyl sulfate. The basic amines may also be quaternized with alkylene oxides such as ethylene oxide or propylene oxide in the presence of acids. Preferred quaternizing agents are: methyl chloride, dimethyl sulfate or diethyl sulfate.

The quaternization can be carried out before or after the polymerization.

The reaction products of unsaturated acids such as, for example, acrylic acid or methacrylic acid, with a quaternized epichlorohydrin of the formula (VI) 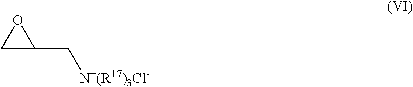
in which
R¹⁷ is C₁-C₄₀-alkyl
can additionally be used.

Examples of such reaction products are (meth)acryloyloxyhydroxy-propyltrimethylammonium chloride and (meth)acryloyloxyhydroxy-propyltriethylammonium chloride.

The basic comonomers can also be cationized by neutralizing them with mineral acids such as, for example, sulfuric acid, hydrochloric acid, hydrobromic acid, hydriodic acid, phosphoric acid or nitric acid, or with organic acids such as, for example, formic acid, acetic acid, lactic acid or citric acid.

Others which can be employed for the monomer units (iii) are, in addition to the abovementioned comonomers, what are known as macromonomers such as, for example, silicone-containing macromonomers with one or more groups capable of undergoing free-radical polymerization, or alkyloxazolin macromonomers, as are described, for example in EP 408 311. This publication and the macromonomers disclosed therein are herewith expressly referred to.

Moreover, fluorine-containing monomers as are described, for example, in EP 558 423, and compounds with a crosslinking activity or molecular weight regulators may also be employed, in combination or on their own.

In accordance with a particular embodiment, copolymers according to the invention contain essentially no monomer units (iii). Accordingly, these copolymers are essentially composed of monomer units (i) and (ii). The amount of monomer units (i) then preferably amounts to 30 mol % to 70 mol % and in particular 40 mol % to 60 mol %, and the amount of monomer units (ii) 30 mol % to 70 mol % and in particular 40 mol % to 60 mol %. A particular type of copolymer according to the invention is composed of approximately 50 mol % monomer units (i) and approximately 50 mol % monomer units (ii), advantageously arranged in alternating sequence. It must be taken into consideration that relatively low molecular weights may result in a deviation from the values stated, owing to an accumulation of specific terminal monomer units.

In accordance with a particular embodiment, copolymers according to the invention comprise monomer units (iii). The monomer units (iii) preferably amount to up to 40 mol % and in particular up to 20 mol %.

As a rule, the copolymers have carboxyl groups, which may be present in acid or salt form. Accordingly, the salts of the above-described copolymers take the form of, in particular, carboxylates, i.e. at least some of the carboxyl groups present in the copolymer is in salt form, as a rule in the form of a base addition salt with a cation M selected from among alkali metal, alkaline earth metal and transition metal cations such as Na⁺, K⁺, Mg⁺⁺, Ca⁺⁺ and Zn⁺⁺, NH₄⁺, and quaternary ammmonium cations such as alkylammonium, dialkylammonium, trialkylammonium and tetraalkylammonium.

It is particularly preferred for at least some of the carboxyl groups to be present in salt form. The carboxylate groups advantageously amount to at least approximately 50 mol % and in particular to at least approximately 75 mol %, based on the theoretically possible amount of carboxyl groups in the copolymer. According to a specific aspect, this percentage is a function of the chain length of the monomer unit (i). Thus, relatively high percentages of carboxylate groups are advantageous in the case of relatively long-chain monomer units (i), for example olefins having more than 30 carbon atoms, while relatively low percentages of carboxylate groups are preferred in the case of relatively short-chain monomer units (i), for example olefins having 20 to 24 carbon atoms or less. On the other hand, the percentage of carboxylate groups can be chosen to be relatively low when relatively high percentages of the carboxyl groups in the copolymer are derivatized with hydrophilic groups. According to a further aspect, it is preferred to choose the percentage of the carboxyl groups in such a way that the pH of an aqueous solution of the copolymer in question is in a range of from approximately 4 to 10 and advantageously from 5 to 8.

As a rule, the copolymers to be used in accordance with the invention have a relatively small contact angle. Especially preferred copolymers are those whose contact angle is less than 120° and preferably less than 100° when determined in the manner known per se using an aqueous solution with a copolymer content of 2% by weight on a paraffin surface.

The surface-active properties of the copolymers depend in particular on the type and distribution of the carboxyl and carboxylic acid derivative grouping. The surface tension of copolymers CP to be used in accordance with the invention, which can be determined by the pendant-drop method, is preferably in the range of from 30 to 80 mN/m and in particular 40 to 60 mN/m for a solution comprising 0.1% by weight of copolymer, in a range of from 25 to 80 mN/m and in particular 35 to 60 mN/m for a solution comprising 0.5% by weight of copolymer, and in a range of from 20 to 70 mN/m and in particular 30 to 55 mN/m for a solution comprising 2.0% by weight of copolymer. Copolymers which are preferably to be used in accordance with the invention thus qualify as amphiphilic substances.

The weight-average molecular weight of the polymers according to the invention is between 500 and 2 000 000, preferably between 1 000 and 500 000, especially preferably between 2 000 and 100 000.

The polymers according to the invention can be prepared by copolymerizing suitable monomers which correspond to the monomer units (i) and (ii) (group (i) and group (ii) monomers, respectively) and, if appropriate, further comonomers corresponding to the monomer units (iii) (group (iii) comonomers). To this end, the monomers or comonomers can be polymerized with the aid of free-radical initiators or else by the action of high-energy radiation, which is also understood as including the action of high-energy electrons (cf., for example, EP 9 169 A1, EP 9 170 A1 and EP 276 464, which are expressly referred to).

Initiators for free-radical polymerization which can be employed are the peroxo and/or azo compounds which are conventionally used for this purpose, for example alkali metal peroxydisulfate or ammonium peroxydisulfate, diacetal peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxydicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, azobis(2-amidonopropane) dihydrochloride or 2,2′-azobis(2-methylbutyronitrile). Others which are suitable are initiator mixtures or redox/initiator systems such as, for example, ascorbic acid/iron(II) sulfate/sodium peroxodisulfate, tert-butyl hydroperoxide/sodium disulfite, tert-butyl hydroperoxide/sodium hydroxymethane-sulfinate. Organic peroxides are preferably employed.

The amounts of initiator or initiator mixtures used are between 0.01 and 10% by weight, preferably between 0.1 and 5% by weight, based on the amounts of monomer employed.

As a rule, the polymerization is carried out in a temperature range of from 40 to 200° C., preferably in a range of from 50 to 140° C., especially preferably in a range of from 60 to 110° C. It is usually carried out under atmospheric pressure, but may also proceed under reduced or elevated pressure, in the latter case preferably between 1 and 5 bar.

The polymerization can be carried out for example in the form of a solution polymerization, bulk polymerization, emulsion polymerization, inverse emulsion polymerization, suspension polymerization, inverse suspension polymerization or precipitation polymerization, without the useful methods being limited thereto.

In the case of bulk polymerization, a procedure may be followed in which the group (i) monomers, the group (ii) monomers and, if appropriate, group (iii) comonomers as further comonomers are mixed with each other, a polymerization initiator is added, and the mixture is then polymerized. The polymerization may also be carried out semibatchwise by first introducing some, for example 10%, of the monomer and comonomer mixture of groups (i), (ii) and, if appropriate, (iii) to be polymerized and the initiator, heating the mixture to polymerization temperature and, when the polymerization has started, the remainder of the mixture to be polymerized is added as a function of the progress of the polymerization. The polymers can also be obtained by charging a reactor with the group (i) monomers, heating the reactor to polymerization temperature, adding at least one group (ii) monomer and, if appropriate, one or more further group (iii) comonomer(s) and polymerization initiator, either all at once, batchwise or, preferably, continuously, and polymerizing the mixture. The polymerization can be carried out with the aid of protective colloids as described, for example, in DT 2840201.

If desired, the above-described polymerization can also be carried out in a solvent. Examples of suitable solvents are alcohols such as methanol, ethanol, n-propanol, isopropanol, n-butanol, sec-butanol, tert-butanol, n-hexanol and cyclohexanol, and glycols such as ethylene glycol, propylene glycol and butylene glycol, and the methyl or ethyl ethers of the dihydric alcohols, diethylene glycol, triethylene glycol, glycerol and dioxane. When using ethylenically unsaturated dicarboxylic acid derivatives of group (ii), solvents which are inert to the carboxylic acid derivatives used are preferably used.

The polymerization may also be carried out in water as the solvent. In this case, a solution is first present which is more or less soluble in water as a function of the amount of the group (i) and (ii) monomers added and, optionally, further group (iii) comonomers which are added. To dissolve water-insoluble products which may be formed during the polymerization, it is possible to add, for example, organic solvents such as monohydric alcohols having 1 to 3 carbon atoms, acetone or dimethylformamide. However, the polymerization in water may also be carried out in such a way that the polymers which are insoluble in water are converted into a finely divided dispersion by adding customary emulsifiers or protective colloids, for example polyvinyl alcohol.

Examples of emulsifiers which are used are ionic or nonionic surfactants with an HLB value in the range of from 3 to 13. As regards the definition of the HLB value, reference is made to the paper by W. C. Griffin, J. Soc. Cosmetic Chem., Vol. 5, 249 (1954).

The surfactants generally amount to 0.1 to 10% by weight, based on the polymer. When using water as solvent, solutions or dispersions of the polymers are obtained. If solutions of the polymer in an organic solvent or in mixtures of an organic solvent and water are prepared, 5 to 2 000, preferably 10 to 500, parts by weight of the organic solvent or solvent mixture are generally used per 100 parts by weight of the polymer.

The copolymers CP, or salts of the copolymers CP, which can be used in accordance with the invention can be obtained in particular by copolymerizing
(1) at least one olefin and/or at least one vinyl ether,
(2) at least one ethylenically unsaturated dicarboxylic acid and/or at least one ethylenically unsaturated dicarboxylic acid derivative, in particular a dicarboxylic acid anhydride, and, optionally
(3) at least one further copolymerizable comonomer,
   and, if appropriate, by carrying out a partial or complete solvolysis and/or derivatization, in particular a hydrolysis, alcoholysis, aminolysis, esterification, transesterification, amidation and/or imidation, of the carboxylic acids and/or carboxylic acid derivatives, in particular of the dicarboxylic acid anhydride groups.

In particular, the copolymer CP′, which results from the copolymerization process, can be subjected to one or more of the following other process steps:
(4) at least partial solvolysis of derivatized carboxylic acid groups;
(5) a derivatization of carboxylic acid groups;
(6) at least partial neutralization of carboxylic acid groups.

The relative amounts of monomers and comonomers to be selected for copolymerization purposes can be seen from what has been said above regarding the ratios of monomer units (i), (ii) and, if appropriate, (iii). In particular, 30 to 70 mol % and preferably 40 to 60 mol % of at least one olefin and/or vinyl ether, 70 to 30 mol % and preferably 60 to 40 mol % of at least one ethylenically unsaturated dicarboxylic acid and/or a dicarboxylic acid derivative and 0 to 40 mol % and preferably 0 to 20 mol % of at least one further copolymerizable comonomer can be copolymerized.

The nature of the monomers or comonomers to be employed depends not only on the monomer units to be formed, rather, it is expedient in a number of cases to polymerize monomers or comonomers which are converted into the desired monomer units subsequently to the polymerization reaction. The course of the reaction and the procedure are frequently the reason for proceeding in such a way.

In particular the monomers which can be used for the monomer units (ii) can differ from the monomer units involved in the synthesis of the copolymer CP. Thus, a frequently used procedure is first to polymerize dicarboxylic acid derivatives, such as the anhydrides or else esters. The monomer units (ii′) thus formed, of the copolymer CP′, are subsequently as a rule subjected to one or more of process steps (4), (5) and/or (6), finally resulting in the copolymer CP or a salt thereof. In this sense, it is also possible to polymerize dicarboxylic acid esters with short-chain, readily hydrolyzable ester groups, such as alkyl esters having preferably 1 to 3 carbon atoms in the alkyl moiety, and their alcohol moiety is subsequently eliminated and, if appropriate, replaced by another alcohol.

Accordingly, the copolymer CP′ which can be obtained by copolymerization comprises, as a rule, carboxyl groups and/or derivatized carboxyl groups, for example anhydride groups or ester groups, which, if desired, are subsequently reacted in a polymer-analogous reaction, as a rule with the formation of carboxyl groups and/or other carboxylic acid derivatives. Preferred polymer-analogous reactions are (4) solvolyses such as hydrolyses, alcoholyses or aminolyses of dicarboxylic acid derivatives and in particular dicarboxylic acid anhydrides, and (5) esterifications and amidations of carboxyl groups.

The reaction of dicarboxylic acid derivatives with the formation of carboxyl groups is termed hydrolysis. The reaction with the formation of further carboxylic acid derivatives may initially comprise hydrolysis of the carboxylic acid derivatives, for example the anhydride groups, with subsequent derivatization, for example esterification, of the resulting carboxyl groups, or the direct derivatization, i.e. conversion of the carboxylic acids and/or carboxylic acid derivatives, for example the anhydride groups, with the formation of carboxylic acid esters or in the sense of a transesterification of carboxylic acid ester groups or an alcoholysis of carboxylic acid anhydride groups, for example with an alcohol. Thus, it may be advantageous initially to hyrolyze at least some of the derivatized carboxyl groups, for example anhydride groups, or to react them with the formation of derivatives. Depending on the choice of the process variants, any remaining derivatized carboxyl groups, for example anhydride groups, can subsequently be derivatized, for example, esterified, or hydrolyzed, and it is also possible to derivatize, for example to esterify or to transesterify, or to hydrolyze, at least some of the resulting carboxyl groups or ester groups, respectively.

In an embodiment, copolymers CP which can be used in accordance with the invention are obtainable by choosing (ii) at least one ethylenically unsaturated dicarboxylic acid anhydride and copolymerizing it with the remaining monomers and comonomers, and hydrolyzing at least some of the anhydride groups of the resulting copolymerization product CP′ and/or reacting them with the formation of derivatives, preferably the formation of esters, in the sense of an alcoholysis.

An especially preferred process is the copolymerization of monomers for monomer units (i) and anhydrides of ethylenically unsaturated dicarboxylic acids and, if appropriate, further monomers for monomer units (iii), followed by at least partial hydrolysis, esterification and/or amidation. A preferred process is the at least partial hydrolysis and/or esterification to give semi-esters. In this context, a procedure can be followed in which some of the anhydride groups are initially reacted with the formation of semi-esters, and all or some of the remaining anhydride groups are subsequently hydrolyzed. Alternatively, it is also possible first to hydrolyze the anhydride groups and subsequently to convert some of the resulting carboxyl groups to give semi-esters.

The polymer-analogous reaction subsequently to the polymerization can be carried out in the presence of a solvent, for example acetone or tetrahydrofuran. Preferably, however, the copolymer CP′ is reacted directly with the derivatizing agent, for example an alcohol corresponding to the above formula (I), or with abovementioned amines. The amount of reactants to be employed depends on the degree of derivatization to be achieved.

If the derivatization takes the form of an esterification reaction or an amidation reaction, this is performed in the customary manner, viz., as a rule, at elevated temperature, for example 50 to 200° C. and preferably at 80 to 150° C., if appropriate in the presence of a customary catalyst, for example p-toluenesulfonic acid. Customary reaction times are in the range of from 0.5 to 20 and in particular 1 to 10 hours. The reaction of anhydride groups which are present in the polymer is preferred. This can be performed in a solvent or, if appropriate, without a solvent. If a solvent is used, then those organic fluids which are inert to anhydride groups and which dissolve or swell not only the starting material, but also the reaction product, which is the at least partially esterified copolymer, are particularly suitable. Substances which must be mentioned in this context are toluene, xylene, ethylbenzene, aliphatic hydrocarbons and ketones such as acetone or methyl ethyl ketone. After the esterification, any solvent which may be present is removed from the reaction mixture, for example by distillation.

The hydrolysis of the copolymers can be carried out for example under alkali conditions. Anydride, ester, amide or imide groups of the copolymer can be hydrolyzed by addition of alkalizing agents such as, for example, ammonium, alkali metal or alkaline earth metal bases and organic bases, for example amines or alkanolamines. It is preferred to hydrolyze the anhydride groups which are present in the polymer. Sodium hydroxide solutions or potassium hydroxide solutions are frequently used for this purpose for practical reasons.

In order to form salts, the polymers can be partially or fully neutralized with bases prior to or after the polymerization, for example in order to bring the solubility or dispersibility in water to the desired level.

Examples of substances which can be employed as neutralizing agents for acid groups are mineral bases such as sodium carbonate, alkali metal hydroxides such as sodium hydroxide or potassium hydroxide, alkaline earth metal hydroxides and ammonia, or organic bases such as alkylamines, dialkylamines, trialkylamines, amino alcohols, specifically isopropylamine, ethylamine, diisopropylamine, diethylamine, triisopropylamine, triethylamine, 2-amino-2-methyl-1-propanol, monoethanolamine, diethanolamine, triethanolamine, triisopropanolamine, tri[(2-hydroxy)-1-propyl]amine, -2-amino-2-methyl-1,3-propanediol, 2-amino-2-hydroxymethyl-1,3-propanediol, and diamines such as, for example, lysin.

According to the use for agrotechnical applications and in particular in the field of crop protection, the copolymers can be employed as stand-alone products and co-applied together with at least one active-ingredient-comprising composition, or else they can be mixed with at least one active-ingredient-comprising composition shortly prior to use and then applied as the resulting mixture, or they may be incorporated in the formulation as coformulant in the form of a ready mix.

Accordingly, the present invention also relates to compositions comprising
(a) at least one active ingredient for the treatment of plants; and
(b) at least one copolymer CP or a salt of the copolymer CP.

In particular, the present invention relates to agrotechnical compositions comprising a copolymer CP or a salt of the copolymer CP, the copolymer CP comprising—besides monomer units (i) of at least one olefin and/or at least one vinyl ether and (iii) if appropriate at least one further copolymerizable monomer—monomer units (ii) of both at least one ethylenically unsaturated dicarboxylic acid and at least one ethylenically unsaturated dicarboxylic acid derivative. According to what has been said above, it is therefore typical for this type of copolymer CP that the copolymers CP comprise not only carboxyl groups, at least some of which may be in salt form in the case of salts of the copolymers, but also derivatized carboxyl groups, in particular esters, amides and imides of the carboxyl groups. Accordingly, these copolymers preferably encompass monomer units (ii) of the formula (VIIq1) and of the formula (VIIq2), in which M and R have the abovementioned meanings. In particular, they include those copolymers where the ratio of monomer units of the formula (VIIq1):(VIIq2) is approximately 5:95 to 95:5, preferably approximately 20:80 to 80:20 and especially preferably approximately 40:60 to 60:40. Those which may be mentioned in this context are mainly radicals R of the formula (I) and in particular of the formula (Ia) and furthermore also the above-described substituted or unsubstituted C₁-C₄₀-alkylamines and di(C₁-C₄₀-alkyl)amines. According to a further aspect, these copolymers encompass in particular monomer units (i) of the formula (VIIp) in which R²¹ and R²² have the above meanings. Especially preferred among these are diisobutene, C₁₈-olefins and C₂₀-C₂₄-olefins.

It is advantageous when component (b) amounts to more than 0.5% by weight, preferably more than 1% by weight and in particular more than 5% by weight based on the total weight of the composition. On the other hand, it is expedient, as a rule, when component (b) amounts to less than 50% by weight, preferably less than 25% by weight and in particular less than 10% by weight based on the total weight of the composition.

In particular, the active ingredient (Component (a)) can be selected among herbicides, fungicides, insecticides, acaricides, nematicides, and active ingredients which regulate plant growth.

Herbicidal crop protection compositions may comprise, for example, one or more of the following herbicidal crop protectants:
1,3,4-thiadiazoles such as buthidazole and cyprazole, amides such as allidochlor, benzoylpropethyl, bromobutide, chlorthiamid, dimepiperate, dimethenamid, diphenamid, etobenzanid, flamprop-methyl, fosamin, isoxaben, monalide, naptalame, pronamid, propanil, aminophosphoric acids such as bilanafos, buminafos, glufosinate-ammonium, glyphosate, sulfosate, aminotriazols such as amitrol, anilides such as anilofos, mefenacet, aryloxyalkanoic acids such as 2,4-D, 2,4-DB, clomeprop, dichlorprop, dichlorprop-P, dichlorprop-P, fenoprop, fluroxypyr, MCPA, MCPB, mecoprop, mecoprop-P, napropamide, napropanilide, triclopyr, benzoic acids such as chloramben, dicamba, benzothiadiazinones such as bentazone, bleachers such as clomazone, diflufenican, fluorochloridone, flupoxam, fluridone, pyrazolate, sulcotrione, carbamates such as carbetamid, chlorbufam, chlorpropham, desmedipham, phenmedipham, vernolate, quinolinecarboxylic acids such as quinclorac, quinmerac, dichloropropionic acids such as dalapon, dihydrobenzofurans such as ethofumesate, dihydrofuran-3-ones such as flurtamone, dinitroanilines such as benefin, butralin, dinitramin, ethalfluralin, fluchloralin, isopropalin, nitralin, oryzalin, pendimethalin, prodiamine, profluralin, trifluralin, dinitrophenols such as bromofenoxim, dinoseb, dinoseb-acetate, dinoterb, DNOC, minoterb-acetate, diphenyl ethers such as acifluorfen-sodium, aclonifen, bifenox, chlornitrofen, difenoxuron, ethoxyfen, fluorodifen, fluoroglycofen-ethyl, fomesafen, furyloxyfen, lactofen, nitrofen, nitrofluorfen, oxyfluorfen, dipyridyls such as cyperquat, difenzoquat-methylsulfate, diquat, paraquat-dichloride, imidazoles such as isocarbamid, imidazolinones such as imazamethapyr, imazapyr, imazaquin, imazethabenz-methyl, imazethapyr, oxadiazoles such as methazole, oxadiargyl, oxadiazon, oxiranes such as tridiphane, phenols such as bromoxynil, ioxynil, phenoxyphenoxypropionic esters such as clodinafop, cyhalofop-butyl, diclofop-methyl, fenoxaprop-ethyl, fenoxaprop-p-ethyl, fenthiapropethyl, fluazifop-butyl, fluazifop-p-butyl, haloxyfop-ethoxyethyl, haloxyfop-methyl, haloxyfop-p-methyl, isoxapyrifop, propaquizafop, quizalofop-ethyl, quizalofop-p-ethyl, quizalofop-tefuryl, phenylacetic acids such as chlorfenac, phenylpropionic acids such as chlorophenprop-methyl, ppi active ingredients such as benzofenap, flumiclorac-pentyl, flumioxazin, flumipropyn, flupropacil, pyrazoxyfen, sulfentrazone, thidiazimin, pyrazoles such as nipyraclofen, pyridazines such as chloridazon, maleic hydrazide, norflurazon, pyridate, pyridinecarboxylic acids such as clopyralid, dithiopyr, picloram, thiazopyr, pyrimidyl ethers such as pyrithiobac-acid, pyrithiobac-sodium, KIH-2023, KIH-6127, sulfonamides such as flumetsulam, metosulam, triazolecarboxamides such as triazofenamid, uracils such as bromacil, lenacil, terbacil, furthermore benazolin, benfuresate, bensulide, benzofluor, butamifos, cafenstrole, chlorthal-dimethyl, cinmethylin, dichlobenil, endothall, fluorbentranil, mefluidide, perfluidone, piperophos.

Preferred herbicidal plant protectants are those of the sulfonylurea type such as amidosulfuron, azimsulfuron, bensulfuron-methyl, chlorimuron-ethyl, chlorsulfuron, cinosulfuron, cyclosulfamuron, ethametsulfuron-methyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron.

Preferred herbicidal plant protectants are furthermore those of the cyclohexenone type such as alloxydim, clethodim, cloproxydim, cycloxydim, sethoxydim and tralkoxydim.

Very especially preferred herbicidal active ingredients of the cyclohexenone type are: tepraloxydim (cf. AGROW, No. 243, 3.11.95, page 21, caloxydim) and 2-(1-[2-{4-chlorophenoxy}propyl-oxyimino]butyl)-3-hydroxy-5-(2H-tetrahydrothiopyran-3-yl)-2-cyclohexen-1-one and of the sulfonylurea type N-(((4-methoxy-6-[trifluoromethyl]-1,3,5-triazin-2-yl)amino)carbonyl)-2-(trifluoromethyl)benzenesulfonamide.

The fungicidal compositions comprise one or more of, for example, the following fungicidal active ingredients: sulfur, dithiocarbamates and their derivatives, such as iron(III) dimethyldithiocarbamate, zinc dimethyldithiocarbamate, zinc ethylenebisdithiocarbamate, manganese ethylenebisdithiocarbamate, manganese zinc ethylenediaminebisdithiocarbamate, tetramethyl-thiuram disulfide, ammonia complex of zinc (N,N-ethylenebis-dithiocarbamate), ammonia complex of zinc (N,N′-propylene-bisdithiocarbamate), zinc (N,N′-propylenebisdithiocarbamate), N,N′-polypropylenebis(thiocarbamoyl)disulfide;
nitro derivatives, such as dinitro(l-methylheptyl)phenyl crotonate, 2-sec-butyl-4,6-dinitrophenyl 3,3-dimethylacrylate, 2-sec-butyl-4,6-dinitrophenylisopropyl carbonate, diisopropyl 5-nitro-isophthalate;
heterocyclic substances, such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)-phosphinyl]-3-phenyl-1,2,4-triazole, 2,3-dicyano-1,4-dithio-anthraquinone, 2-thio-1,3-dithiolo[4,5-b]quinoxaline, methyl 1-(butylcarbamoyl)-2-benzimidazolecarbamate, 2-methoxycarbonyl-aminobenzimidazole, 2-(2-furyl)benzimidazole, 2-(4-thiazolyl)-benzimidazole, N-(1,1,2,2-tetrachloroethylthio)tetrahydro-phthalimide, N-trichloromethylthiotetrahydrophthalimide, N-trichloromethylthiophthalimide;
N-dichlorofluoromethylthio-N′,N′-dimethyl-N-phenylsulfodiamide, 5-ethoxy-3-trichloromethyl-1,2,3-thiadiazole, 2-thiocyanato-methylthiobenzothiazole, 1,4-dichloro-2,5-dimethoxybenzene, 4-(2-chlorophenylhydrazono)-3-methyl-5-isoxazolone, pyridine-2-thiol 1-oxide, 8-hydroxyquinoline or its copper salt, 2,3-dihydro-5-carboxanilido-6-methyl-1,4-oxathiine, 2,3-dihydro-5-carboxanilido-6-methyl-1,4-oxathiine 4,4-dioxide, 2-methyl-5,6-dihydro-4H-pyran-3-carboxanilide, 2-methylfuran-3-carbox-anilide, 2,5-dimethylfuran-3-carboxanilide, 2,4,5-trimethylfuran-3-carboxanilide, N-cyclohexyl-2,5-dimethylfuran-3-carboxamide, N-cyclohexyl-N-methoxy-2,5-dimethylfuran-3-carboxamide, 2-methylbenzanilide, 2-iodobenzanilide, N-formyl-N-morpholine-2,2,2-trichloroethyl acetal, piperazine-1,4-diylbis-1-(2,2,2-trichloroethyl)formamide, 1-(3,4-dichloroanilino)-1-formylamino-2,2,2-trichloroethane, 2,6-dimethyl-N-tridecylmorpholine or its salts, 2,6-dimethyl-N-cyclododecylmorpholine or its salts, N-[3-(p-tert-butylphenyl)-2-methylpropyl]-cis-2,6-dimethylmorpholine, N-[3-(p-tert-butyl-phenyl)-2-methylpropyl]piperidine, 1-[2-(2,4-dichlorophenyl)-4-ethyl-1,3-dioxolan-2-yl-ethyl]-1H-1,2,4-triazole, 1-[2-(2,4-dichlorophenyl)-4-n-propyl-1,3-dioxolan-2-ylethyl]-1H-1,2,4-triazole, N-(n-propyl)-N-(2,4,6-trichlorophenoxyethyl)-N′-imidazolylurea, 1-(4-chlorophenoxy)-3,3-dimethyl-1-(1H-1,2,4-triazol-1-yl)-2-butanone, 1-(4-chlorophenoxy)-3,3-dimethyl-1-(1H-1,2,4-triazol-1-yl)-2-butanol, (2RS,3RS)-1-[3-(2-chlorophenyl)-2-(4-fluorophenyl)oxiran-2-ylmethyl]-1H-1,2,4-triazole, a-(2-chlorophenyl) -a-(4-chloro-phenyl)-5-pyrimidinemethanol, 5-butyl-2-dimethylamino-4-hydroxy-6-methylpyrimidine, bis(p-chlorophenyl)-3-pyridinemethanol, 1,2-bis(3-ethoxycarbonyl-2-thioureido)benzene, 1,2-bis(3-methoxy-carbonyl-2-thioureido)benzene,
strobilurins such as methyl E-methoxyimino-[a-(o-tolyloxy)-o-tolyl]acetate, methyl E-2-{2-[6-(2-cyanophenoxy)pyrimidin-4-yloxy]phenyl}-3-methoxyacrylate, N-methyl-E-methoxyimino-[a-(2-phenoxyphenyl)]acetamide, N-methyl E-methoxyimino-[a-(2,5-dimethylphenoxy)-o-tolyl]acetamide,
anilinopyrimidines such as N-(4,6-dimethylpyrimidin-2-yl)aniline, N-[4-methyl-6-(1-propynyl)pyrimidin-2-yl]aniline, N-[4-methyl-6-cyclopropylpyrimidin-2-yl]aniline,
phenylpyrroles such as 4-(2,2-difluoro-1,3-benzodioxol-4-yl)-pyrrole-3-carbonitrile,
cinnamamides such as 3-(4-chlorophenyl)-3-(3,4-dimethoxyphenyl)-acryloylmorpholine,
and a variety of fungicides such as dodecylguanidine acetate, 3-[3-(3,5-dimethyl-2-oxycyclohexyl)-2-hydroxyethyl]glutarimide, hexachlorobenzene, methyl N-(2,6-dimethylphenyl)-N-(2-furoyl)-DL-alaninate, DL-N-(2,6-dimethylphenyl)-N-(2′-methoxyacetyl)-alanine methyl ester, N-(2,6-dimethylphenyl)-N-chloroacetyl-D,L-2-aminobutyrolactone, DL-N-(2,6-dimethylphenyl)-N-(phenyl-acetyl)alanine methyl ester, 5-methyl-5-vinyl-3-(3,5-dichloro-phenyl)-2,4-dioxo-1,3-oxazolidine, 3-[3,5-dichlorophenyl-(5-methyl-5-methoxymethyl]-1,3-oxazolidine-2,4-dione, 3-(3,5-dichlorophenyl)-1-isopropylcarbamoylhydantoin, N-(3,5-dichlorophenyl)-1,2-dimethylcyclopropane-1,2-di-carboximide, 2-cyano-[N-(ethylaminocarbonyl)-2-methoximino]-acetamide, 1-[2-(2,4-dichlorophenyl)pentyl]-1H-1,2,4-triazole, 2,4-difluoro-a-(1H-1,2,4-triazolyl-1-methyl)benzhydryl alcohol, N-(3-chloro-2,6-dinitro-4-trifluoromethylphenyl)-5-trifluoro-methyl-3-chloro-2-aminopyridine, 1-((bis-(4-fIuorophenyl)methyl-silyl)methyl)-1H-1,2,4-triazole.

Useful growth regulators are, for example, the group of the gibberellins. These include, for example, the gibberellins GA₁, GA₃, GA₄, GA₅ and GA₇ and the like, and the corresponding exo-16,17-dihydrogibberellins and the derivatives thereof, for example the esters with C₁-C₄-carboxylic acids. Preferred in accordance with the invention is exo-16,17-dihydro-GA₅-13-acetate.

In accordance with one embodiment of the present invention, the active ingredient component (a) consists essentially of one or more of the following preferred active ingredients: bentazone, difenzoquat, pendimethalin, quinclorac, cycloxydim, quinmerac, sethoxydim, cinidon-ethyl, mecoprop, mecoprop-P, dichlorprop, chloridazon, dicamba, metobromuron, profoxydim, tritosulfuron, diflufenzopyr, s-dimethenamid, cyanazine, picolinafen, cyclosulfamuron, imazamethabenz-methyl, imazaquin, acifluorfen, nicosulfuron, sulfur, dithianon, tridemorph, metiram, nitrothal-isopropyl, thiophanate-methyl, metholachlor, triforine, cerbendazim, vinclozolin, dodine, fenpropimorph, epoxiconazole, kresoxim-methyl, pyraclostrobin, dimoxystrobin, cyazofamid, fenoxalin, dimethomorph, metconazole, dimethoate, chlorfenvinphos, phorate, fenbutatin oxide, chlorfenapyr, simazine, bensulforon, flufenoxuron, terflubenzuron, alphacypermetrin, cypermethrin, hydramethylnon, terbufos, temephos, halofenozide, flocoumafen, triazamate, flucythrinate, hexythiazox, dazomet, chlorocholin chloride, mepiquat-chloride, prohexadion-calcium, or of one or more of the following very especially preferred active ingredients: metazachlor, paraquat, glyphosate, imazethaphyr, tepraloxydim, imazapic, imazamox, acetochlor, atrazine, tebufenpyrad, trifluralin, pyridaben.

In particular, the present invention relates to compositions comprising high percentages of active ingredient (concentrates). Thus, as a rule, component (a) amounts to more than 10% by weight, preferably more than 20% by weight and in particular more than 25% by weight of the total weight of the composition. On the other hand, as a rule, component (a) expediently amounts to less than 70% by weight, preferably less than 60% by weight and in particular less than 50% by weight of the total weight of the composition.

Besides, the formulations according to the invention may comprise auxiliaries and/or additives which are conventionally used in the preparation of formulations used in the field of crop protection. These include, for example, surfactants, dispersants, wetters, thickeners, organic solvents, cosolvents, antifoams, carboxylic acids, preservatives, stabilizers and the like.

In accordance with a particular embodiment of the present invention, the compositions comprise at least one (further) surfactant as surface-active component (c). In this context, the term ♭surfactant” refers to surface-active agents.

Component (c) is added in particular in the form of a dispersant or emulsifier, mainly for dispersing a solid in suspension concentrates. Moreover, parts of component (c) may act as wetters.

Surfactants which can be used in principle are anionic, cationic, nonionic and amphoteric surfactants, including polymer surfactants and surfactants with heteroatoms in the hydrophobic group.

The anionic surfactants include, for example, carboxylates, in particular alkali metal, alkaline earth metal and ammonium salts of fatty acids, for example potassium stearate, which are usually also referred to as soaps; acyl glutamates; sarcosinates, for example sodium lauroyl sarcosinate; taurates; methylcelluloses; alkyl phosphates, in particular alkyl esters of mono- and diphosphoric acid; sulfates, in particular alkyl sulfates and alkyl ether sulfates; sulfonates, furthermore alkylsulfonates and alkylarylsulfonates, in particular alkali metal, alkaline earth metal and ammonium salts of arylsulfonic acids and of alkyl-substituted arylsulfonic acids, alkylbenzenesulfonic acids, such as, for example, lignosulfonic acid and phenolsulfonic acid, naphthalene- and dibutylnaphthalenesulfonic acids, or dodecylbenzenesulfonates, alkylnaphthalenesulfonates, alkyl methyl ester sulfonates, condensates of sulfonated naphthalene and derivatives thereof with formaldehyde, condensates of naphthalenesulfonic acids, phenol- and/or phenolsulfonic acids with formaldehyde or with formaldehyde and urea, mono- or dialkyl sulfosuccinates; and protein hydrolysates and lignin-sulfite waste liquors. The abovementioned sulfonic acids are advantageously used in the form of their neutral or, if appropriate, basic salts.

The cationic surfactants include, for example, quaternized ammonium compounds, in particular alkyltrimethylammonium halides, dialkyldimethylammonium halides, alkyltrimethylammonium alkyl sulfates, dialkyldimethylammonium alkyl sulfates and pyridine and imidazoline derivatives, in particular alkylpyridinium halides.

The nonionic surfactants include, for example, the alkoxylates, mainly ethoxylates, and nonionic surfactants, in particular
fatty alcohol polyoxyethylene esters, for example lauryl alcohol polyoxyethylene ether acetate,
alkyl polyoxyethylene ethers and alkyl polyoxypropylene ethers, for example of iso-tridecyl alcohol, and fatty alcohol polyoxyethylene ethers, alkylaryl alcohol polyoxyethylene ethers, for example octylphenol polyoxyethylene ether,
alkoxylated animal and/or vegetable fats and/or oils, for example corn oil ethoxylates, castor oil ethoxylates, tallow fat ethoxylates,
glycerol esters such as, for example, glycerol monostearate,
fatty alcohol alkoxylates and oxo alcohol alkoxylates, in particular of the type RO—(R₁₈O)ᵣ(R₁₉O)ₛR₂₀ where R₁₈ and R₁₉ independently of one another=C₂H₄, C₃H₆, C₄H₈ and R₂₀═H, or C₁-C₁₂-alkyl, R═C₃-C₃₀-alkyl or C₆-C₃₀-alkenyl, r and s independently of one another are 0 to 50, where one of these must be other than 0, such as iso-tridecyl alcohol and oleyl alcohol polyoxyethylene ether,
alkylphenol alkoxylates such as, for example, ethoxylated isooctylphenol, octylphenol or nonylphenol, tributylphenyl polyoxyethylene ethers,
fatty amine alkoxylates, fatty acid amide alkoxylates and fatty acid diethanolamide alkoxylates, in particular their ethoxylates,
sugar surfactants, sorbitol esters such as, for example, sorbitan fatty acid esters (sorbitan monooleate, sorbitan tristearate), polyoxyethylene sorbitan fatty acid esters, alkylpolyglycosides, N-alkylgluconamides,
alkylmethyl sulfoxides,
alkyldimethylphosphine oxides such as, for example, tetradecyldimethylphosphine oxide.

The amphoteric surfactants include, for example, sulfobetaines, carboxybetaines and alkyldimethylamine oxides, for example tetradecyldimethylamine oxide.

The polymeric surfactants include, for example, di-, tri- and multi-block polymers of the types (AB)ₓ, ABA and BAB, for example optionally end-capped ethylene oxide/propylene oxide block copolymers, e.g. ethylene diamine EO/PO block copolymers, polystyrene block polyethylene oxide, and AB comb polymers, for example polymethacrylate comb polyethylene oxide.

Further surfactants to be mentioned in the present context by way of example are perfluoro surfactants, silicone surfactants, e.g. polyether-modified siloxanes phospholipids such as, for example lecithin or chemically modified lecithins, amino acid surfactants, for example N-lauroylglutamate, and surface-active homo- and copolymers, for example polyvinylpyrrolidone, polyacrylic acids in the form of their salts, polyvinyl alcohol, polypropylene oxide, polyethylene oxide, maleic anhydride/isobutene copolymers and vinylpyrrolidone/vinyl acetate copolymers.

Unless specified, the alkyl chains of the abovementioned surfactants are linear or branched radicals, usually having 8 to 20 carbon atoms.

The further surfactant as regards component (c) is preferably selected from among nonionic surfactants. Preferred among the nonionic surfactants are, in particular, those with HLB values ranging from 2 to 13, preferably from 5 to 13, in particular from 8 to 13.

As a rule, component (c)—if present—amounts to less than 50% by weight, preferably less than 15% by weight and in particular less than 5% by weight of the total weight of the composition.

In accordance with a particular embodiment of the present invention, the compositions comprise at least one further auxiliary as component (d).

Component (d) can fulfill a variety of objectives. Suitable auxiliaries are chosen in the customary manner by the skilled worker to suit the requirements.

For example, further auxiliaries are selected from among
(d1) solvents or diluents;
(d2) emulsifiers, delayed-release agents, pH buffers, antifoams.

Besides water, the compositions may comprise further solvents of soluble components or diluents of insoluble components of the composition.

Examples which are useful in principle are mineral oils, synthetic oils, vegetable oils and animal oils, low-molecular-weight hydrophilic solvents such as alcohols, ethers, ketones and the like.

Those which must therefore be mentioned are, firstly, aprotic or apolar solvents or diluents, such as mineral oil fractions of medium to high boiling point, for example kerosene and diesel oil, furthermore coal tar oils, hydrocarbons, paraffin oils, for example C₈— to C₃₀-hydrocarbons of the n- or iso-alkane series or mixtures of these, optionally hydrogenated or partially hydrogenated aromatics or alkylaromatics from the benzene or naphthalene series, for example aromatic or cycloaliphatic C₇— to C₁₈-hydrocarbon compounds, aliphatic or aromatic carboxylic acid esters or dicarboxylic acid esters, or fats or oils of vegetable or animal origin, such as mono-, di- and triglycerides, in pure form or in the form of a mixture, for example in the form of oily extracts of natural materials, for example olive oil, soya oil, sunflower oil, castor oil, sesame seed oil, corn oil, groundnut oil, rapeseed oil, linseed oil, almond oil, safflower oil, and their raffinates, for example hydrogenated or partially hydrogenated products thereof and/or their esters, in particular the methyl and ethyl esters.

Examples of C₈— to C₃₀-hydrocarbons of the n- or iso-alkane series are n- and iso-octane, -decane, -hexadecane, -octadecane, -eicosane, and preferably hydrocarbon mixtures such as liquid paraffin (technical-grade liquid paraffin may comprise up to approximately 5% aromatics) and a C₁₈-C₂₄ mixture which is commercially available from Texaco under the name Spraytex oil.

The aromatic or cycloaliphatic C₇— to C₁₈ hydrocarbon compounds include, in particular, aromatic or cycloaliphatic solvents from the series of the alkyl-aromatics. These compounds may be unhydrogenated, partially hydrogenated or fully hydrogenated. Such solvents include, in particular, mono-, di- or trialkylbenzenes, mono-, di- or trialkyl-substituted tetralins and/or mono-, di-, tri- or tetraalkyl-substituted naphthalenes (alkyl is preferably C₁-C₆-alkyl). Examples of such solvents are toluene, o-, m-, p-xylene, ethylbenzene, isopropylbenzene, tert-butylbenzene and mixtures, such as the Exxon products sold under the names Shellsol and Solvesso, for example Solvesso 100, 150 and 200.

Examples of suitable monocarboxylic esters are oleic esters, in particular methyl oleate and ethyl oleate, lauric esters, in particular 2-ethylhexyl laurate, octyl laurate and isopropyl laurate, isopropyl myristate, palmitic esters, in particular 2-ethylhexyl palmitate and isopropyl palmitate, stearic esters, in particular n-butyl stearate and 2-ethylhexyl 2-ethylhexanoate.

Examples of suitable dicarboxylic esters are adipic esters, in particular dimethyl adipate, di-n-butyl adipate, di-n-octyl adipate, di-iso-octyl adipate, also referred to as bis(2-ethylhexyl)adipate, di-n-nonyl adipate, di-iso-nonyl adipate and di-tridecyl adipate; succinic esters, in particular di-n-octyl succinate and di-iso-octyl succinate, and di(iso-nonyl)cyclohexane 1,2-dicarboxylate.

As a rule, the above-described aprotic solvents or diluents amount to less than 80% by weight, preferably less than 50% by weight and in particular less than 30% by weight of the total weight of the composition.

Some of these aprotic solvents or diluents may also have adjuvant properties, that is to say in particular synergistic properties. This applies in particular to said mono- and dicarboxylic esters. From this point of view, such adjuvants may also be mixed with the copolymers according to the invention or with compositions comprising them at an expedient point in time, as a rule shortly prior to application, to take the form of a part of a further formulation (stand-alone product).

Secondly, solvents or diluents which must be mentioned are protic or polar solvents or diluents, for example C₂-C₈-monoalcohols such as ethanol, propanol, isopropanol, butanol, isobutanol, tert-butanol, cyclohexanol and 2-ethylhexanol, C₃-C₈-ketones such as diethyl ketone, t-butyl methyl ketone and cyclohexanone, and aprotic amines such as N-methyl- and N-octylpyrrolidone.

As a rule, the above-described protic or polar solvents or diluents amount to less than 80% by weight, preferably less than 50% by weight and in particular less than 30% by weight of the total weight of the composition.

Sedimentation inhibitors may also be used, in particular for suspension concentrates. Their main purpose is the rheological stabilization. Products which must be mentioned in this context are, in particular, mineral products, for example bentonites, talcites and hectorites.

Other additions which may be useful can be found for example among mineral salt solutions which are employed for alleviating nutritional and trace element deficiencies, nonphytotoxic oils and oil concentrates, antidrift reagents, antifoams, in particular the silicone type products, for example Silicon SL, which is sold by Wacker, and the like.

The formulations may be present in the form of an emulsifiable concentrate (EC), a suspoemulsion (SE), an oil-in-water emulsion (O/W), a water-in-oil emulsion (W/O), an aqueous suspension concentrate, and oil suspension concentrate (SC), a microemulsion (ME) and the like.

The compositions can be prepared in the manner known per se. To this end, at least some of the components are combined. It must be taken into consideration that products, in particular commercially available products, can be used whose constituents may contribute to different components. For example, a specific surfactant can be dissolved in an aprotic solvent, so that this product can contribute to different components. Furthermore, it is also possible that minor amounts of less desired substances are introduced together with commercially available products. As a rule, the products which have been combined to a mixture must then be mixed thoroughly with each other to give a homogeneous mixture and, if appropriate, milled, for example in the case of suspensions.

Mixing can be carried out in a manner known per se, for example by homogenizing with suitable devices such as KPG stirrers or magnetic stirrers.

Milling, too, is a process which is known per se. The milling elements used can be made of glass or can be other mineral or metallic milling elements, as a rule in a size of from 0.1-30 mm and in particular 0.6-2 mm. As a rule, the mixture is comminuted until the desired particle size has been achieved.

In general, milling may be carried out as a recirculation process, i.e. by continuously cycling an SC, or as a batch process, i.e. the complete and repeated processing of a batch.

Grinding can be effected with conventional ball mills, bead mills or agitated mills, for example in a Dynomuhle mill (Bachofen) with batch sizes of, for example, from 0.5 up to 1 liter in what is known as a batch operation. After several passes, in particular 4 to 6 passes (the suspension being pumped through the mill with the aid of a peristaltic pump), evaluation under the microscope reveals mean particle sizes of from 0.5 to 10 mm.

As a rule, the compositions are diluted in the customary manner prior to use to obtain a form which is suitable for application. Dilution with water or else aprotic solvents, for example by the tank mix method, is preferred. The use in the form of a slurry preparation is preferred. The application may be pre- or post-emergence. Post-emergence application results in particular advantages.

Particular advantages result mainly when carrying out a spray treatment. A customary spray mixture to be used as a tank mix involves diluting, per hectare, approximately 0.01 to 10, preferably approximately 0.5 to 5 and in particular 0.5 to 2 kg of the composition according to the invention with water to give 5 to 1 500 1 and in particular 50 to 1 000 l. If appropriate, 0.5% by weight to 50% by weight (based on spray mixture) of (further) anionic, cationic or nonionic surfactants, auxiliaries, polymers and/or the abovementioned active ingredients are added to the spray mixture to be used as a tank mix. Examples of substances which can act as such surfactants and further auxiliaries have already been described above. Substances which must be mentioned in particular are starch and starch derivatives, for example a carboxyl- and sulfo-containing starch (Nu-Film by Union Carbide Corp.) and spreaders and extenders, such as Vapor Guard by Miller Chemical & Fertilizer Corp.

With a view to its use as an adjuvant, the composition already containing the copolymer according to the invention—or other plant treatment compositions to which the copolymer is added as a “stand alone” product—is diluted with water so that about 0.01 to 10, preferably about 0.1 to 1 kg of at least one copolymer according to the invention is applied.

For the purposes of the present description, terms such as alkyl, alkoxy and the like encompass straight-chain or branched hydrocarbon groups such as methyl, ethyl, n-propyl, i-propyl, n-butyl, i-butyl, sec-butyl, t-butyl, n-pentyl, n-hexyl, n-octyl, 2-ethylhexyl, n-nonyl, iso-nonyl, n-decyl, iso-decyl, n-undecyl, iso-undecyl, n-dodecyl, iso-dodecyl, n-tridecyl, iso-tridecyl, stearyl, n-eicosyl, preferably—unless otherwise specified—having 1 to 8, in particular 1 to 6 and especially preferably 1 to 4 carbon atoms in the case of short-chain radicals and 6 to 40, in particular 8 to 24 and especially preferably 12 to 24 carbon atoms in the case of long-chain radicals.

The term “cycloalkyl” encompasses mono- or bicyclic saturated hydrocarbon groups which are optionally mono-, di- or trisubstituted by C₁-C₄-alkyl, such as cyclopropyl, cyclobutyl, cyclopentyl and especially cyclohexyl, and the like, preferably—unless otherwise specified—having 3 to 10, in particular 3 to 6 and especially preferably 6 carbon atoms.

The term “aryl” preferably represents phenyl, thus also naphthyl.

For the purposes of the present description, quantities generally refer to the total weight of a composition, unless otherwise specified. As a rule, the term “essentially” refers in accordance with the invention to a percentage of at least 90%, preferably at least 95% and in particular at least 98%.

The invention is illustrated in greater detail by the examples which follow:

### PREPARATION EXAMPLES

### REFERENCE EXAMPLES 1 TO 4

Preparation of the Copolymers a to d

The copolymers a to d are composed of the units of the formulae (VIIIp), (VIIIq1) and (VIIIq2):

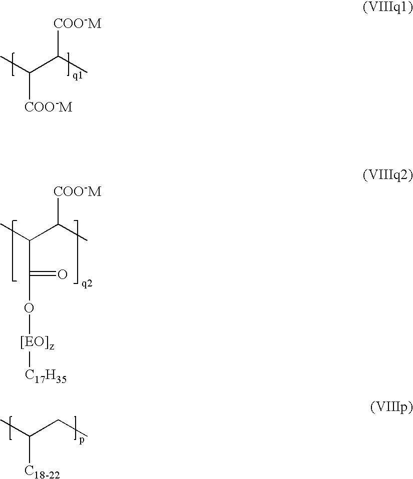

where M is hydrogen or Na⁺ and the variables p, q1, q2 and z have the following meanings:

TABLE 1
Structure of copolymers a-d according to the invention
(the values p, q1 and q2 indicate the relative percentages in
mol %)

| CP | p | q1 | q2 | z |
|---|---|---|---|---|
| a | 0.5 | 0.25 | 0.25 | 11 |
| b | 0.5 | 0.25 | 0.25 | 25 |
| c | 0.5 | 0.25 | 0.25 | 80 |
| d | 0.5 | 0.5 | 0 | 0 |

A steel reactor which is equipped for polymerization reactions and provided with a stirring and dosing devices is charged with 1 195 g of a C₂₀-C₂₄-olefin 1 mixture and the mixture is heated with stirring to 190° C. under a gentle stream of nitrogen. Once this temperature is reached, 392 g of maleic anhydride which has been heated at 70° C. and, separately, 16 g of di-tert-butyl peroxide are added uniformly in the course of 4 hours. The reaction mixture is subsequently stirred for 2 hours at 190° C. and then subjected either to hydrolysis or to solvolysis.

To carry out the solvolysis (copolymers a, b and c), an alkyl polyglycol ether of a C₁₇-oxo alcohol (C_{16/18}-oxo alcohol mixture with an ethylene oxide block of 11 (1 450 g, for the synthesis of copolymer a), 25 (2 665 g, for the synthesis of copolymer b), and 80 (6 878 g, for the synthesis of copolymer c), respectively, is run into the stirred reaction mixture at 150° C. and the mixture is stirred for 5 hours. The stirred reaction mixture is then cooled to 90° C. Then, 160 g of a 50% strength aqueous sodium hydroxide solution and such an amount of water with a temperature of 90° C. that a solution with a solids content of 30% results are then added separately in the course of half an hour. The reaction mixture is stirred for 4 hours in a temperature range of from 90 to 95° C. and then cooled to ambient temperature. This gives a fluid aqueous dispersion of a copolymer in which 50 mol % of all of the carboxyl groups formed are neutralized.

To carry out the hydrolysis (polymer d), the stirred reaction mixture is cooled to 90° C. Then, 320 g of a 50% strength aqueous sodium hydroxide solution and 3 909 g of water with a temperature of 90° C. are added separately in the course of half an hour. The reaction mixture is stirred for 4 hours in a temperature range of from 90 to 95° C. and then cooled to ambient temperature. This gives a fluid aqueous dispersion of a copolymer which has a solids content of 30% and in which 50 mol % of all of the carboxyl groups formed are neutralized.

### EXAMPLE 1

### Herbicidal Efficacy of the Bentazone Formulations

The copolymers shown in Table 1 were applied by the tank mix method together with Basagran (480 g/l bentazone). The application rate per ha was 0.125 kg of bentazone and 2, 1.0 and 0.5 kg of a.i./ha copolymer or comparative surfactant Wettol LF 700 (alcohol alkoxylate). The herbicidal effect was assessed in a greenhouse experiment. The test plants used were soybeans (Glycine max; GLXMA), Chinese hemp (Abutilon theophrasti; ABUTH), white goosefoot (Chenopodium album; CHEAL) and ladysthumb (Polygonum persicaria; POLPE). These plants were either sown separately for each species or first grown separately as seedlings and transplanted into the experimental containers a few days before the treatment. The experimental containers used were plastic pots containing loamy sand and approximately 3.0% of humus as substrate. As soon as the plants had reached a height of 3-20 cm, depending on their habit, they were treated with the formulations. The application rate for the post-emergence treatment was 0.125 kg a.i./ha bentazone and 2.0, 1.0 or 0.5 kg a.i./ha copolymer or comparative surfactant.

The test period extended over 2 to 4 weeks. During this time, the plant species were kept specifically at night-time temperatures above 14° C. and day-time temperatures between 20 and 31° C., tended, and their response to the individual treatments was evaluated.

Evaluation was done using a scale from 0 to 100. 100 means no emergence of the plants, or complete destruction of at least the aerial parts, and 0 means no damage, or normal course of growth.

The results of the assessment are compiled in Table 2 which follows.

| | Bentazone | Adjuvant | | | | |
|---|---|---|---|---|---|---|
| Adjuvant | (kg/ha) | (kg/ha) | GLXMA | ABUTH | CHEAL | POLPE |
| — | 0.125 | — | 0 | 64 | 9 | 86 |
| a | 0.125 | 2 | 1 | 65 | 69 | 89 |
| a | 0.125 | 1 | 0 | 73 | 66 | 85 |
| a | 0.125 | 0.5 | 0 | 51 | 55 | 91 |
| a | 0.125 | Average | 0 | 63 | 63 | 88 |
| b | 0.125 | 2 | 0 | 70 | 61 | 99 |
| b | 0.125 | 1 | 0 | 81 | 48 | 100 |
| b | 0.125 | 0.5 | 0 | 74 | 21 | 86 |
| b | 0.125 | Average | 0 | 75 | 43 | 95 |
| c | 0.125 | 2 | 0 | 70 | 59 | 100 |
| c | 0.125 | 1 | 0 | 68 | 63 | 100 |
| c | 0.125 | 0.5 | 0 | 59 | 60 | 96 |
| c | 0.125 | Average | 0 | 66 | 61 | 99 |
| d | 0.125 | 2 | 0 | 89 | 34 | 86 |
| d | 0.125 | 1 | 0 | 64 | 30 | 88 |
| d | 0.125 | 0.5 | 0 | 71 | 28 | 86 |
| d | 0.125 | Average | 2 | 75 | 31 | 87 |
| Wettol | 0.125 | 2 | 35 | 91 | 49 | 83 |
| LF700 | | | | | | |
| Wettol | 0.125 | 1 | 30 | 70 | 53 | 86 |
| LF700 | | | | | | |
| Wettol | 0.125 | 0.5 | 19 | 65 | 49 | 70 |
| LF700 | | | | | | |
| Wettol | 0.125 | Average | 28 | 75 | 50 | 80 |
| LF700 | | | | | | |

It can be seen clearly that formulations with copolymer according to the invention were considerably more effective than the comparative formulations without adjuvant, or than the comparative formulations which contained only Wettol LF700, an alcohol ethoxylate, instead of copolymers according to the invention. Furthermore, it can be seen clearly that formulations with copolymer according to the invention impart better selectivity to the active ingredient, which can be seen from the fact that soybean suffers less plant damage.

1. An agrotechnical composition comprising at least one copolymer or a salt of the copolymer comprising the monomer units
(i) of at least one olefin,
(ii) at least one ethylenically unsaturated dicarboxylic acid and at least one ethylenically unsaturated dicarboxylic acid derivative, and, optionally,
(iii) at least one further copolymerizable comonomer
wherein the dicarboxylic acid derivative is a dicarboxylic acid monoester or dicarboxylic acid diester with an alcohol moiety of the formula (I)
(R¹)ₙ—X—(CHR²CH₂O)_{w}—(CHR³CH₂O)ₓ—(CHR⁴(CH₂)_{y}O)_{z}— (I),
in which
R¹ is hydrogen, or branched or linear, saturated or unsaturated C₁₋₄₀-alkyl;
R², R³, R⁴ independently of one another are hydrogen or C₁₋₄-alkyl;
w, x, z independently of one another correspond to a value of from 0 to 100;
y corresponds to a value of from 1 to 20;
x is N or 0,
where n=1 if x=0, or n=2 and the total of w, x and z amounts to at least 1 if X═N.

2. A composition as claimed in claim 1, wherein the dicarboxylic acid derivative is a dicarboxylic acid monoester with an alcohol moiety of the formula (I)
(R¹)ₙ—X—(CHR²CH₂O)_{w}—(CHR³CH₂O)ₓ—(CHR⁴(CH₂)_{y}O)_{z}—
in which
R¹ is hydrogen, or branched or linear, saturated or unsaturated C₁₋₄₀-alkyl;
R², R³, R⁴ independently of one another are hydrogen or C₁₋₄-alkyl;
w,x,z independently of one another correspond to a value of from 0 to 100;
y corresponds to a value of from 1 to 20;
x is N or O
where n=1 if X=0, or n=2 and the total of w, x and z amounts to at least 1 if X═N.

3. A composition as claimed in claim 1, wherein the alcohol moiety is alkoxylated.

4. A composition as claimed in claim 1, wherein the ratio of ethylenically unsaturated dicarboxylic acids to dicarboxylic acid derivatives is 5:95 to 95:5.

5. A composition as claimed in claim 1, wherein the ratio is 40:60 to 60:40.

6. A composition as claimed in claim 1, wherein the dicarboxylic acid is maleic acid and the dicarboxylic acid monoester or dicarboxylic acid diester is a maleic acid monoester or a maleic acid diester.

7. A composition as claimed in claim 1, wherein the copolymer comprises monomer units (ii) of the formula (VIIq1) and the formula (VIIq2) 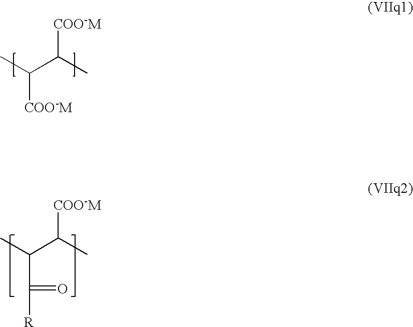
in which
M radicals are in each case independently of one another a hydrogen atom or a cation selected from among alkali metal, alkline earth metal and transition metal cations, in particular Na⁺, K⁺, Mg⁺⁺, Ca⁺⁺ and Zn⁺⁺, NH₄⁺ and quaternary ammonium cations, in particular alkylammonium dialkylammonium, trialkylammonium and tetraalkylammonium and
R is a residue of formula (I).

8. A composition as claimed in claim 7, wherein the residue R in formula (VIIq2) is an alcohol residue of the formula (Ia)
R¹—O—(C₂H₄O)_{z}— (Ia)
in which
R¹ is hydrogen, or branched or linear, saturated or unsaturated C₁₋₄₀-alkyl; and
z corresponds to a value of from 1 to 100.

9. A composition as claimed in claim 1, wherein the copolymer comprises monomer units (i) of the formula (VIIp) 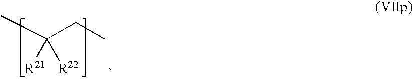
R²¹, R²² independently of one another are hydrogen, branched or linear, saturated or unsaturated C₂₋₃₈-alkyl, or optionally C₁₋₄-alkyl-substituted phenyl.

10. A composition as claimed in claim 9, wherein R²¹ is hydrogen and R²² is C₆₋₂₂-alkyl.

11. A composition as claimed in claim 1, wherein the olefin is selected from among isobutene, diisobutene, C₁₈-olefin mixtures and C₂₀-C₂₄-olefin mixtures.

12. A composition as claimed in claim 1, wherein the further copolymerizable comonomer is selected from among (meth)acrylic acid, (meth)acrylamide, (meth)acrylonitrile, alkyl (meth acrylates, carboxylic acid vinyl esters, alkyl vinyl ethers and N-alkyl- or N-aryl-substituted maleimides.

13. A composition as claimed in claim 1, wherein at least 50 mol-% of the carboxyl groups which are present in total in the copolymer are in salt form.

14. A composition as claimed in claim 1, wherein a copolymer or a salt thereof which can be obtained by copolymerizing
(1) 30 TO 70 mol-T of at least one olefin and/or at least one vinyl ether,
(2) 70 to 30 mol-% of at least one ethylenically unsaturated dicarboxylic acid anhydride, and
(3) 0 to 40 mol-% of at least one further copolymerizable comonomer, and at least partial alcoholysis of the carboxylic acid anhydride groups with an alcohol corresponding to the alcohol residue of the copolymer and, subsequently at least partial hydrolysis of the remaining carboxylic acid anhydride groups.

15. A composition as claimed in claim 1 comprising at least one active ingredient for plant treatment, which is selected from the herbicides, fungicides, insecticides, acaricides, nematicides and active ingredients that regulate plant growth

16. A method of teating a plant, said method comprising applying to the plant an effective amount of a copolymer or a salt of the copolymer comprising the monomer units
(i) of at least one olefin and/or at least one vinyl ether,
(ii) at least one ethylenically unsaturated dicarboxylic acid and/or at least one ethylenically unsaturated dicarboxylic acid derivative, and, optionally,
(iii) at least one further copolymerizable comonomer.

17. The method as claimed in claim 16 wherein the efficacy of a crop protection is improved.

18. The method as claimed in claim 16, wherein the copolymer or the salt thereof comprises the monomer units
(i) of at least one olefin,
(ii) at least one ethylenically unsaturated dicarboxylic acid and at least one ethylenically unsaturated dicarboxylic acid derivative, and, optionally,
(iii) at least one further copolymerizable comonomer wherein the dicarboxylic acid derivative is a dicarboxylic acid monoester or dicarboxylic acid diester with an alcohol moiety of the formula (I)
(R¹)ₙ—X—(CHR²CH₂O)_{w}—(CHR³CH₂O)ₓ—(CHR⁴(CH₂)_{y}O)_{z}— (I),
in which
R¹ is hydrogen, or branched or linear, saturated or unsaturated C₁-₄₀-alkyl;
R², R³, R⁴ independently of one another are hydrogen or C₁₋₄-alkyl;
w,x, z independently of one another correspond to a value of from 0 to 100;
y corresponds to a value of from 1 to 20;
x is N or 0.
where n=1 if X=0, or n=2 and the total of w, x and z amounts to at least 1 if X═N.

19. The method as claimed in claim 17, wherein the crop protection is effected with a herbicide.

20. The method as claimed in claim 19 wherein the copolymer is applied post-emergence.

21. The method as claimed in claim 20 wherein the copolymer is part of a composition which is sprayed on the plant.
